(19) United States
(12) Patent Application Publication
(10) Pub. No.: US 2013/0346133 A1
(43) Pub. Date: Dec. 26, 2013

(54) Method for Habit-Making Towards Achieving a Goal

(71) Applicant: ELEVATE TECHNOLOGIES PTY LTD, Melbourne (AU)

(72) Inventors: Hesham SOLIMAN, Melbourne (AU); Timothy Eric STROTH, Hampton Victoria (AU)

(21) Appl. No.: 13/926,504

(22) Filed: Jun. 25, 2013

Related U.S. Application Data
(60) Provisional application No. 61/663,801, filed on Jun. 25, 2012.

(51) Int. Cl. G06Q 10/06

(52) U.S. Cl. CPC G06Q 10/063114
USPC 705/7.15

(57) ABSTRACT

Systems and methods of assisting users achieve goals are provided. A user provides goals to a server, which identifies habits required to achieve the goals. The server monitor's the user's progress towards the goal and sends notifications to the user informing the user of his/her progress and encouraging the user to develop habits towards achieving the goal.

### CROSS-REFERENCE TO RELATED APPLICATIONS

The present application claims priority to U.S. Provisional Application No. 61/663,801, filed Jun. 25, 2012, the entire disclosure of which is herein expressly incorporated by reference.

### BACKGROUND OF THE INVENTION

People are constantly pursuing goals in their lives, which range from physical improvements (weight loss or fitness), to managing disease, to success in business or financial management. Countless exercise and weight loss products are sold. An even larger and more diverse number of books and other educational materials have and continue to be published intended to help people motivate themselves to take some category of actions intended to help them achieve their goals, teach the behavior of successful people (in business or other matters), or general self help books that teach spirituality. In addition, several professions exist specifically to assist their clients to change their behavior in order to achieve some outcome. Examples of such professions include doctors, psychologists, counselors, personal trainers, financial advisors and behavioral, life, and businesses coaches.

### SUMMARY OF THE INVENTION

Currently there is no mechanism for incorporating an individual's one or more habits that are the prerequisites for any person to achieve their goal(s). Although there are examples of individuals successfully forming a new habit and using one or more products to successfully reach their goals, these habits are generally formed independently of the products in question and only by a very small percentage of consumers who have enough self-discipline to achieve the habit formation in a self directed way. When a professional is used, new habits are still only formed by a minority percentage of clients and come at a substantial financial cost to the consumer.

Exemplary embodiments of the present invention provide systems and methods to proactively drive people to build new habits that help them reach their goals. This invention is widely applicable to a variety of different habits, including habits related to exercise, eating healthy foods, medication compliance, business or professional goals, financial goals, among others.

An exemplary system includes an electronic device configured to accept entry by a user of enter one or more pieces of information relating to a goal or preconfigured with a specific goal purpose and the activity or activities or habit(s) required to achieve that goal or the habit(s), activity, activities or decision types that must be altered or influenced in order to achieve that goal and that then interacts with the user by way of one or more of the following; prompting action, prompting interaction with the system, and/or soliciting further information from the user.

The system can also monitor the users progress based on either or both data collected by user interaction or automatically collected through user activity (e.g. pedometer, glucose testing results, etc) and dynamically adjust its prompts, requested interactions, their frequency and/or their nature based on the users activity. For example, if the user's goal is weight loss and the user is not lowering his/her caloric intake, then based on information from the pedometer the system can prompt the user to increase the number of steps the user takes per day by a certain amount.

The system can also establish a cue intended to prompt the user to take specific associated actions. Furthermore, the system can establish and track intervening stages between a starting point and a goal designed to optimize the likelihood of the user forming a habit.

The system can also prompt the user to reward themselves at specific or random intervals in order to optimize the individuals likelihood of forming a habit. Additionally, information related to the goal may include one or more of the goal, an associated habitualized activity that will lead to the goals achievement, a statement of intent regarding the goal or activity, details on their prescribed consumption of medication or self testing regime, intervening steps or stages of activity or accomplishment between a starting point and their goal, a cue, a starting level of activity, or one or more rewards.

The system can adapt or alter the prompts and requested interactions presented to the user and/or their frequency and timing based on the users activity and/or data input by the user or collected by the system directly or from integrated or connected devices. Prompts, messages or requests interaction with the user can be based on the user's location, which can be determined, for example, by GPS, a known Wi-Fi network, a Wi-Fi network name, etc.

In accordance with exemplary embodiments of the present invention a system comprises a user's computing device and a server that allows users to define their goals and maps them to the habits required to achieve those goals. The system interacts with users to monitor their progress and encourage them to continue towards their goals. The system performs the monitoring using notification messages. Users are progressed through levels of commitment towards their goals. Users can use an application on their device to interact with the system or a generic web browser.

The user's data can be collected through a questionnaire answered by the user to identify their current levels of commitment and the user's personality type. Additionally, the user's data can be collected through users' devices, which report on various health functions. The user's data can also be collected through external systems, including health records storage systems or financial systems. Furthermore, the user's data can be collected through authorized personnel nominated by the user.

Notifications can be sent via text messages or email. The notifications can be interactive messages requiring the user's response. Push technologies can be used to deliver the notification messages to the user's device. The user's responses to notifications are provided by the user communicating with a voice recognition system. The notification messages can customized according to the user's personality type, to the rate of the user's progress.

The systems and methods of the present invention can be used for achieving a goal related to weight loss, fitness activities, financial advice and budgeting, medication compliance, and/or chronic disease management.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block diagram of a system in accordance with the present invention;

FIG. 2 is a functional diagram of an exemplary habit making server in accordance with the present invention; and

FIG. 3 is a flow diagram of an exemplary method in accordance with the present invention.

### DETAILED DESCRIPTION

The present invention is designed to assist people achieve their goals by translating them into habits that are identified, created, monitored, supervised and maintained through proactive and dynamic interactions.

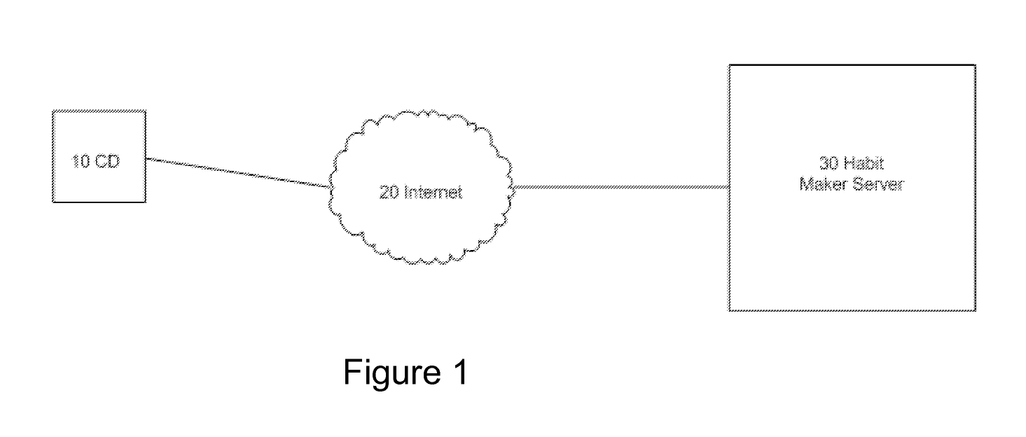

FIG. 1 is a block diagram of an exemplary system in accordance with the present invention. The system includes a consumer's computer device (CD) 10, a network (e.g., the Internet) 20, and a habit maker server (HMS) 30.

The consumer's computing device (CD) 10 is a computer operated by the consumer. The CD 10 can be, for example, a mobile telephone (e.g., a smart phone, personal digital assistant (PDA), etc.), a computer with wired or wireless connectivity, or a device with no internet connectivity. The CD 10 includes a non-transitory memory that stores software (e.g. a software application downloaded from a website or an application store) specifically designed to communicate with the HMS 30 or the CD 10 can communicate with the HMS 30 using generic software built into the CD 10 (e.g. a web browser). The CD 10 also includes a processor (e.g., a microprocessor, field programmable gate array (FPGA), application specific integrated circuit (ASIC), etc.), that executes the software to support the functionality described herein.

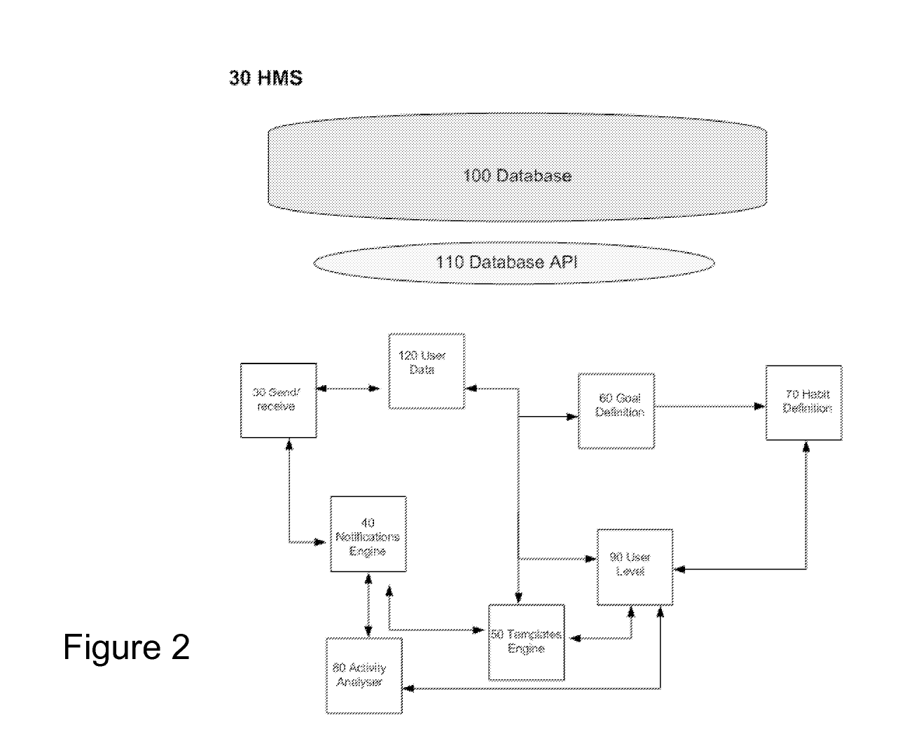

Internet 20 is a network of routers and/or switches that connect the CD 10 to the Habit Maker Server 30. The Habit Maker Sever (HMS) 30 is a server containing a number of software modules to support the functionality of the present invention and is described in more detail below in connection with FIG. 2.

Although FIG. 1 illustrates the CD 10 and HMS 30 as separate components connected through a network, the CD 10 and the HMS 30 can be collocated within the same device and do not require an Internet connection to function.

FIG. 2 is a functional diagram of the HMS 30. HMS 30 includes software modules 30-90 and 120, a database 100 for data storage and a database application programming interface (API) 110, which allows various software modules to communicate with the database. Any of the software modules shown in FIG. 2 may write or read data from the database 100. It should be recognized that HMS 30 can be a conventional server that executes the software modules 30-90 and 120. In any event, HMS 30 includes one or more processors and one or more memories (e.g., random access memory (RAM), read-only memory (ROM), and storage (e.g., solid state drives (SSD), hard drives, etc.), as well as a communication interface for connecting to Internet 20.

Send/receive module 30 is responsible for communications between the HMS 30 and the CD 10. This module encodes/decodes and encrypts/de-crypts data between the communicating entities, manages the connection and performs other functions like connection data flow control. In one embodiment in this invention, data is encoded in the eXtendable Markup Language (XML) or the Java Script Object Notation (JSON) or the HyperText Markup Language (HTML) standard over the HyperText Transfer Protocol (HTTP). In another embodiment of this invention, data is sent using the User Datagram Protocol (UDP). Data may be encrypted using symmetric or asymmetric cryptographic techniques, whose keys are setup using a number of current or future key exchange mechanisms.

User Data module 120 is responsible for collecting data about the user that will initialize the user's state based on questions put to the user, as well as, monitoring the user's progress based on interactive dialogues with the user, in addition to data sent by the user or on behalf of the user through one of their devices or carers who have access to the user's account (i.e., a person that cares for the user). For example, assuming that a user wants to build the habit of exercising daily, the user would be asked a number of initial questions, the answers to which, are stored in the user data module 120. These answers are used by the system to assess the user's current commitment to exercise. In one embodiment of this invention, the user data module 120, also collects data about the user's health through access to medical information provided by the user or a medical device owned by the user. In another embodiment of this invention the user data module 120 collects information about the user's progress through interactive messaging with the user or one of their carers.

The user data module 120 also collects information from the user about their goals and habits that they desire to achieve. In one embodiment of this invention, the user's goals are collected and later translated by the system into habits required to achieve such goals. In another embodiment of this invention, the user's desired habits are collected directly from the user.

Goal Definition module 60 contains all goals supported by the system. Goals can be defined by the system administrator as deemed necessary. The Goal Definition module translates the defined goals into relevant habits based on rules defined by the system administrator. For example, if the user's goal is to get fit, this module will translate that goal into the relevant habit of exercise. That is, in this case the user needs to create the habit of exercising regularly in order to get fit. For example, the habit can be performing certain types of activities on a periodic basis (e.g., daily, weekly, etc.).

Habit Definition module 70 contains the definitions of habits and their relationship to goals defined in the goal definition module 60. The mapping of habits to goals is what allows the above translation to take place. The system can be configured statically or dynamically with goals and their corresponding habits. For instance, a goal of better management of diabetes maybe translated into one or more habits, such as the habit of taking medications on time.

User Level module 90 calculates the user's current commitment to a habit, which represents the user's progress towards establishing the habit. For example, if during a given period there are 10 total activities required to establish the habit and the user has completed five of these activities then the user's commitment would be 50%. The current commitment is initialized based on information available for the user and is continuously updated based on interactions with the user, which can be forwarded from the user data module 120. In one embodiment of this invention, the user level module 90 communicates the user's level to nominated carers, friends of family of the user. In another embodiment of this invention, the user level module 90 communicates the user level to the user's friends or family through social networks. In another embodiment of this invention, the user level module 90 requests that the user communicates their current level to their friends or family. The user level module 90 is also responsible for informing other modules of changes in the user level in order to adjust notifications to the user and the content of messages based on the user's latest level of commitment.

Template Engine module 50 is responsible for generating templates containing messages that are sent to the user. In one embodiment of this invention, the messages generated are customized for each user based on their level of commitment and progress. In another embodiment of this invention, messages may be customized based on the user's personality type, which is stored in the user data module 120. In another embodiment of this invention messages may be customized based on the media where the message is sent (e.g. text messages, email or other forms).

Activity Analyzer module 80 is responsible for analyzing the user's activities based on interactions with the user. The user activity indicates their progress towards achieving their goal and complying with their desired habit. The activity analyzer 80 receives the user's responses and decides whether or not the user is making progress and whether they should remain on the same level. In one embodiment of this invention, the user's interaction with the system is based on electronic communications. In another embodiment of this invention, the user's activity level can be determined without the user's involvement through trusted devices reporting on behalf of the user, or a trusted human entering information about the user's activity. In another embodiment of this invention, the user's activity is determined through authorized access to the user's records in other systems. For instance, a user could provide the service access to their medical records, their financial transactions, or their exercise diary, which might be stored on another system.

Notification Engine module 40 is responsible for interacting with the user, sending reminders and alerts to the CD 10. In one embodiment of this invention, notifications are sent via text message or email to any of the user's registered devices or accounts. In another embodiment of this invention, notifications are sent through push technologies available on the CD 10. In another embodiment of this invention, notifications are interactive, where a user receives a message that requires a response. In another embodiment of this invention, notifications are sent through automated voice-based calls, where voice recognition mechanisms are used to recognize the user's answers if a notification required an answer. Alternatively, notifications may be delivered via a call center operator and answers can be recorded on the system. In another embodiment of this invention, notifications are customized according to the user's location. For instance, certain prompts may be necessary to encourage or discourage the user from performing an activity that might be tempting due to its proximity. The notification engine uses custom message templates generated by the template engine 50 to send message in the form provided.

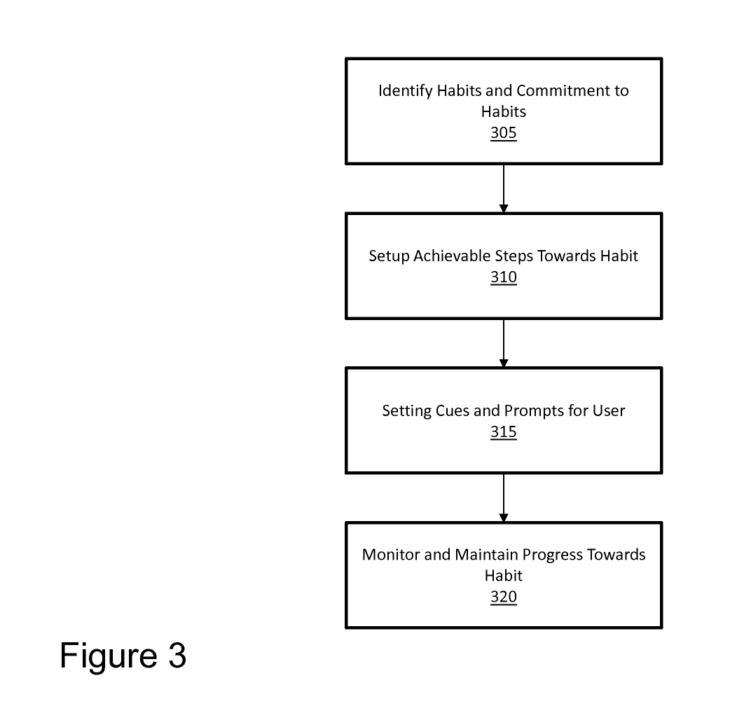

Now that the overall system has been described, the interaction between the user and the system in order to commit to habits and ensure that the user sustains those habits will be discussed in detail in connection with the method illustrated in FIG. 3. In accordance with exemplary embodiments of the present invention users are enabled to commit to their habits by identifying habits and committing to them (step 305), setting up achievable steps towards the habit (step 310), setting cues and prompts for the user (step 315), and monitoring and maintaining progress towards the habit (step 320).

When the user interacts with the system (CD 10 and HMS 30) they may select a goal that they want to achieve, or select the habit directly in order to identify and commit to one or more habits (step 305). When they select a goal, the system maps that goal to the one or more habits that need to be sustained to reach that goal.

The user may then identify a number of sources that can be used to learn about their daily activities. This includes, health records, health and fitness devices and financial records among other sources. The user may also answer a number of questions that are associated with their habits, which allow the system to learn the user's current state, personality types and lifestyle, among other aspects.

Once the user has committed to one or more habits, a plan is set for the user that includes a number of milestones (step 310). In one embodiment of this invention, the user may define their milestones. At each milestone, the user progresses further towards the goal. In one embodiment of this invention, the user is rewarded when reaching key milestones. Rewards may be pre-defined by the user. Rewards may be material or moral, like for instance announcing the user's progress to others.

In another embodiment of this invention, the user is asked whether they would be interested in competing with others towards achieving the same habits. In the case of competition, results maybe announced regularly to encourage users to progress.

As part of setting up a plan, cues are associated with planned actions in order to encourage the user to progress. A plan may be altered along the way depending on the user's progress.

Cues are associated with actions defined in the plan. Prompts are sent to remind the user to perform actions using the notifications engine 40 (step 315). Follow-up interactive communication is also performed via the notifications engine 40 (step 320). The system may follow-up with the user after the time the user was supposed to perform their actions to enquire whether the action was performed. This provides the system with the feedback necessary to determine the user's level of commitment and progress. This information is fed to the User Level module 90, after being processed by the Activity Analyzer module 80.

Cues and notifications may be customized depending on the user's data available, the level of progress, the user's location and the user's personality type. Furthermore, cues and prompts maybe customized based on the user's initial reasons for making the commitment. For example, a lagging user maybe reminded of the reason they wanted to pick up the habit in the first place. They maybe reminded of their hope to manage their disease, quit smoking, better-manage their finances, and so on.

One example of how the systems and method could be used in the present invention in connection with a weight loss goal will now be described. Initially, CD 10 conveys the weight loss goal to the HMS 30. HMS 30 uses logic 60 and 70 to identify habits and commitments to habit as well as set achievable steps towards the identified habits (steps 305 and 310). HMS 30 uses Activity Analyzer module 80 to analyze the user's activities based on interactions with the user, for example by collecting data from a health monitoring device or the user providing information (e.g., types of workout activities and length of activities, caloric intake, etc.). Based on the monitored progress HMS 30 sets cues and prompts for the user towards the habits (step 315). For example, HMS 30 could send a message, which is based on a template from logic 50, informing the user that he/she needs to either increase calories burned or decrease caloric intake. Further, HMS 30 could determine that the user is currently located in a fast food restaurant and send a message indentifying low calorie menu options at that restaurant. HMS 30 then continues to monitor and maintain the user's progress towards the habit (step 320).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method, comprising:
receiving, by an electronic device, entry by a user of one or more pieces of information relating to a goal;
receiving, by the electronic device, entry by the user of one or more activities or habits required to achieve the goal or
receiving, by the electronic device, entry by the user of the habits, activities, or decision types that must be altered or influenced to achieve the goal; and
interacting, by the electronic device, with the user to achieve the goal by prompting action, prompting interaction with a habit making server, or soliciting further information from the user.

2. The method of claim 1, further comprising:
monitoring, by the habit making server, progress by the user towards the goal based at least one of data collected by the interaction with the user interaction or data automatically collected through an activity of the user; and
dynamically adjusting, by the habit making server based on the monitoring, content of prompts, content of requested interactions, frequency of prompts or requested interactions.

3. The method of claim 1, further comprising:
establishing a cue that prompts the user to take specific associated actions.

4. The method of claim 1, further comprising:
defining intervening stages between a starting point and a goal designed to optimize a likelihood of the user forming a habit.

5. The method of claim 1, further comprising:
prompting the user to reward itself at specific or random intervals so as to optimize the user's likelihood of forming a habit.

6. The method of claim 1, wherein information related to the goal includes one or more of the goal, an associated habitualized activity that will lead to achievement of the goal, a statement of intent regarding the goal or activity, details on the user's prescribed consumption of medication or self testing regime, intervening steps or stages of activity or accomplishment between a starting point and their goal, a cue, a starting level of activity, or one or more rewards

7. The method of claim 1, wherein the prompts and requested interactions presented to the user are adapted or altered based on the users activity or data input by the user or data collected by directly from the user or from integrated or connected devices, or
wherein a frequency and timing of the prompts and requested interactions are adapted or altered based on the users activity or data input by the user or data collected by directly from the user or from integrated or connected devices.

8. The method of claim 1, wherein the interaction with the user is based on the user's current location.

9. A system comprising:
a user computing device; and
a server configured to interact with the user computer device to allow a user to define goals and to map the defined goals to habits required to achieve the goals,
wherein the system is configured to monitor the user's progress and encourage the user to continue towards the goals using notification messages.

10. The system of claim 9, wherein the user computing device includes a dedicated application or a web browser configured to interact with the server.

11. The system of claim 9, wherein the server is configured to provide the user computing device with a questionnaire and to use answers provided by the user computing device to identify a user's current level of commitment and the user's personality type.

12. The system of claim 9, further comprising:
a health monitoring device configured to collect data regarding the user's health.

13. The system of claim 9, wherein the server is configured to collect information about the user from external systems, wherein the external systems include health records storage systems or financial systems.

14. The system of claim 9, wherein the server is configured to collect data about the user from authorized personnel nominated by the user.

15. The system of claim 9, wherein the notifications are sent as text messages or email.

16. The system of claim 9, wherein the notifications are interactive messages requiring a response from the user.

17. The system of claim 9, wherein the notification messages use pushed the user computing device.

18. The system of claim 9, further comprising:
a voice recognition system configured to collect the user's responses to the notification messages.

19. The system of claim 9, wherein the notification messages are customized according to the user's personality type.

20. The system of claim 9, wherein the notification messages are customized according to a rate of the user's progress towards one of the defined goals.

21. The system of claim 9, one of the defined goals relates to weight loss, a fitness activity, financial advice, budgeting, medication compliance, or chronic disease management.
